(19) United States
(12) Patent Application Publication
(10) Pub. No.: US 2017/0286380 A1
(43) Pub. Date: Oct. 5, 2017

(54) ELECTRONIC DOCUMENT PROCESSING SYSTEMS AND METHODS FOR COMMUNICATIONS COMMERCE

(71) Applicant: Eadwacer Holdings, LLC, Charleston, SC (US)

(72) Inventors: Christopher Finn, Charleston, SC (US); Amit Biswas, Kolkata (IN); Bhaskar Basu, Kolkata (IN)

(73) Assignee: Eadwacer Holdings, LLC, Charleston, SC (US)

(21) Appl. No.: 15/090,840

(22) Filed: Apr. 5, 2016

(51) Int. Cl. G06F 17/24

(52) U.S. Cl. CPC G06F 17/24; G06F 17/243

(57) ABSTRACT

Systems and platforms are provided for transforming an inert document on a first mobile device into an activated document for manipulation on a second mobile device including receipt of a natural signature on the activated document in a mobile environment.

### BACKGROUND OF THE DISCLOSURE

Editing, signing, resizing, and merging files such as “JPG” and “PDF” documents conventionally require processing the documents using a number of devices such as printers, scanners, and desktop computers as well as multiple software tools such as stamps and annotation applications before the documents can be sent to and transmitted on mobile communications devices. In other words, known systems and software do not permit wholly managing, editing, signing, and processing JPG (Joint Photographic Experts Group) and PDF (Portable Document Format) documents from handheld or portable communications devices such as cellular telephones (“cell phones”) or “smart phones”. For instance, a conventional mobile communications device only allows a user to open and view a PDF document and perhaps add a generic electronic signature (“e-signature”) provided through a particular mobile application. The mobile device user is unable with known smart phone technology to sign an authentic or actual, personal signature in real-time on a PDF while displayed on the smart phone. Moreover, conventional document handling does not permit the user to edit, move, or merge documents on the mobile device prior to signature.

Mobile communications devices are used increasingly as stand-alone devices by users wishing to conduct business in remote locations without access to or the need for desktop computers and peripheral support equipment. The inability to manipulate documents on a mobile communications device and coordinate authentic, personal signatures between mobile devices is a tremendous drawback in the industry of electronic commerce.

What is needed in the communications and e-commerce industry is a system that enables a user to manipulate and process documents such as PDFs and JPGs on a mobile device; that provides a signature indicator on the document to another user of another portable device; and that permits real-time, personal signatures on the processed documents with unique timestamps associated with a discrete identifier of a particular mobile device.

### BRIEF SUMMARY OF THE DISCLOSURE

The present disclosure is directed in general to electronic commerce and communications systems and processes that permit signing, marking, scanning, editing, rearranging and/or merging of documents on portable devices in mobile environments. The various embodiments of the disclosure enable a user to conduct business quickly and easily from anywhere, which saves time and reduces costs of doing business. The present disclosure provides truly paperless documentation that enables a smart phone or other mobile device to function as a mobile office without need of a desktop computer, a scanner or a printer.

More specifically, a mobile device such as an iPhone®, iPad®, Android®, or other portable computer or communications device is enabled to scan documents; import and export documents; edit documents; rearrange and remove documents from document pages; add documents or pages to other documents; e-sign documents and mark an area in a document for signature or to be initialed under a MobiDocx™ marking system, and then electronically mail (email) the processed document to another mobile device for a personal, true and natural signature or initials. The system is cost-effective and easy to download, activate, and use on mobile devices.

According to one embodiment of the present disclosure, a system for digitally marking a document on a mobile device may include a first mobile platform embedded with a first application configured for transforming an inert document into an operational document on the first mobile platform; wherein a target area is marked within the operational document on the first mobile platform; and a second mobile platform embedded with a second application compatible with the first application; wherein, upon receipt of the operational document, the second mobile platform enables a natural signature in the target area.

The first and second mobile platforms in this and other aspects of the disclosure may be a smart telephone, a portable pad, a portable laptop computer or other mobile device. The inert document may be a PDF document, a DOC (Word™ document), DOCX, XLS (Excel™), XLSX, or PPT (PowerPoint™) extension document, a text, an HTML (hypertext markup language) document, an RTF (Rich Text Format) document, a CSV (comma-separated values) document, a JPG, BMP (bitmap image), PNG (Portable Network Graphics), or TIFF (Tagged Image File Format) image, and combinations thereof.

Also in this aspect as well as others disclosed here, the natural signature may be applied by a user's fingertip, a stylus or other writing instrument capable of interacting with a display such as a screen of the mobile device.

According to another aspect of the disclosure, a method for digitally marking a document on a mobile device may include loading an application on an initiating mobile platform, the application being configured to manipulate a digital document by transforming the digital document using a manipulation protocol, the protocol enabling addition of document markers selected from the group consisting of a natural signature, natural initials, a date, text, images and combinations thereof; generating the document markers in the transformed digital document; sending the transformed digital document to a recipient mobile platform; creating a tertiary digital document from the transformed digital document by addition on the recipient mobile platform of at least one of the natural signature, the natural initials, the date, the text, the images or a discrete recipient mobile platform identifier; and returning the tertiary digital document to the initiating mobile platform.

In yet another exemplary aspect of the disclosure, a system for merging documents on a mobile device may include providing a mobile platform embedded with an application configured for transforming a first inert document into a first operational document and for transforming a second inert document into a second operational document, wherein upon activation of the application, the mobile platform causes the first operational document and the second operational document to merge.

Also according to the disclosure a system for applying natural signatures to a document on a mobile device may include importing a document into a first mobile platform; transforming the document into an activated document on the first mobile platform, the activated document enabled to receive a natural signature, a natural initial set, a date, a text, an image, a discrete recipient mobile platform identifier and combinations thereof; receiving the activated document on a second mobile platform; and adding in the activated document on the second mobile platform at least one of the natural signature, the natural initial set, the date, the text, the image and the discrete recipient mobile platform identifier to form an authenticated document. The authenticated document may then be returned to the first mobile platform according to the exemplary protocol.

In yet another aspect of the disclosure, a mobile system serving activated documents may include (a) an interactive mobile application containing an inert document defining a plurality of visually perceptible elements, the interactive mobile application belonging to a first portable host, wherein the inert document is activated by the interactive mobile application to associate an interactive marker to transform the inert document into an activated document; and (b) a second portable host in communication with the first portable host, the second portable host programmed to: receive from the first portable host the activated document and a prompt; automatically identify the interactive marker among the plurality of visually perceptible elements corresponding to the prompt; in response to identification of the interactive marker, automatically retrieve stored data to enable a response to the prompt; and using the data retrieved, enable the response in the form of a natural signature or natural initials and to transmit to the first portable host a tertiary document that displays: unique identifying information associated with the second portable host; and the natural signature or the natural initials disposed at the interactive marker among the plurality of visually perceptible elements.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a series of screenshots showing a scanning process according to an aspect of the disclosure;

FIG. 2 is a series of screenshots showing a document merge process according to another aspect of the disclosure;

FIG. 3 is a series of screenshots showing a document rearrangement process according to yet another aspect of the disclosure;

FIG. 4 is a series of screenshots showing a document importing process according to a further aspect of the disclosure;

FIG. 5 is a series of screenshots showing a document renaming process according to another aspect of the disclosure;

FIG. 6 is a series of screenshots showing a document converting process according to an additional aspect of the disclosure;

FIG. 7 is a series of screenshots showing a page deletion process according to a further aspect of the disclosure;

FIG. 8 is a series of screenshots showing an document editing process according to another aspect of the disclosure;

FIG. 9 is a series of screenshots showing a document signature marking process according to yet another aspect of the disclosure;

FIG. 10 is a series of screenshots showing a document opening process according to an additional aspect of the disclosure;

FIG. 11 is a series of screenshots showing a document signing and time stamp process according to another aspect of the disclosure; and

FIG. 12 shows the exemplary document as in FIG. 11, particularly a time stamp according to a feature of the disclosure.

### DETAILED DESCRIPTION OF THE DISCLOSURE

With MobiDocx™ systems disclosed herein, digital work processes are improved and expedited. For instance, a user may mark a document using a Mobimark™ marking system, sign, initial, scan, merge, remove and edit documents while in a mobile environment. The MobiDocx™ systems described herein are compatible, for instance, with Dropbox™ and Google® Drive™, which allows users to expedite paperwork and close deals faster.

Further, the MobiDocx™ systems are powered by software that creates a unique time stamp and authenticates a document for user records when using “E-sign” and “Mobimark™” features described below. The document can be edited and/or signed, merged, rearranged, or have pages removed from mobile platforms in remote locations and situations.

In general, the present disclosure provides systems and methods for improving operations and functionality of portable devices such as hand-held cellular telephones, laptops, tablets, pads and the like whereby a mobile device is enabled to merge and manage documents such as PDFs and to designate a signature line, place or target point on a PDF on a first mobile device and to receive a real-time, personal signature on a second mobile device having a unique mobile device identifier for signature authentication.

In the detailed description that follows various terms and acronyms are used, including the following:

API. An application-programming interface, which is a set of programming instructions and standards for accessing a software application via the Internet. Typically, a software company will publish or release its API to the public for other software developers to design products to exploit the software application.

Application Program. Within the context of computer hardware and software, an application program is a set of one or more computer programs that performs a function when executed within a computer hardware device. If the set is comprised of multiple programs, the programs are coordinated to perform a function together but such programs may individually perform other functions. Similarly, a program may be comprised of multiple modules that perform certain functions individually and other functions when combined in various ways.

Communications device(s). Any electronic device having a screen and an interactive interface such as a keyboard or touchpad to enable a user to receive or send messages. Optionally, the screen also serves as the input device, and is a touch screen. Examples include but are not limited to desktop computers, smart appliances, and the like. Mobile or portable computing and/or communications devices include but are not limited to laptops, tablets, pads, wearable communications systems, telephones such as cellular phones or smart phones, and vehicle systems.

Internet. A collection of interconnected (public and/or private) networks that are linked together by a set of standard protocols (such as TCP/IP and HTTP) to form a global, distributed network and which are connected by fixed-line or wireless network devices. (While this term is intended to refer to what is now commonly known as the Internet, it is also intended to encompass variations that may be made in the future, including changes and additions to existing standard protocols.)

Identifier or stamp. A distinctive identifier associated with unique identifying information of a mobile device, usually an alphanumeric sequence unique to the mobile device.

Web Server. A device for transmitting data over the Internet (or preventing transmission), which encompasses hardware/software components that serve information content over a network and hardware/software components that interact with a server component to perform services for users.

Web Site. A computer system that serves informational content over a network using the standard protocols of the World Wide Web. Typically, a Web site corresponds to a particular Internet domain name and includes the content associated with a particular individual, business, or organization.

TCP/IP. TCP (Transmission Control Protocol) is a set of rules or a protocol used with Internet Protocol (IP) to send data between computers over the Internet. IP handles delivery of the data and TCP tracks individual units of data or packets into which a message is divided for efficient routing.

Web socket. A TCP-based protocol that permits increased interaction between a communications device such as a browser and a web site and provides a way for a server to send content to the browser without solicitation by a client. A web socket permits messages to be passed back and forth while keeping a connection open such that a two-way (bi-directional) ongoing conversation can occur.

Network Application Server. The hardware and software components of a server that manages information over network connections such as internet networks, cellular networks, and the like over which users exchange information.

Decompile/disassemble (compile/assemble). Generally, decompile means to translate computer readable program code (object code) into a higher level of abstraction such as human readable source code (decompiled source code usually does not contain every detail of original source code). Disassembly, too, generally refers to the translation of executable machine code into human readable text; however, disassembly does not generate the more concise, higher level text that results from decompiling. To map the content of a communications device including contact information and field data, translation of code by decompiling or disassembly may be involved.

The foregoing definitions are not intended to limit the scope of the present disclosure, but rather are intended to clarify terms that are well understood by persons having ordinary skill in the art. It should be appreciated that the defined terms may also have other meanings to such persons having ordinary skill in the art. These and other terms are used in the detailed description below.

Detailed reference will now be made to the drawings in which examples embodying the present subject matter are shown. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. However, the examples set forth in the drawings and detailed descriptions are provided by way of explanation only and are not meant as limitations of the disclosure. The present subject matter thus includes any modifications and variations of the following examples as come within the scope of the appended claims and their equivalents. The detailed description uses numerical and letter designations to refer to features of the drawings.

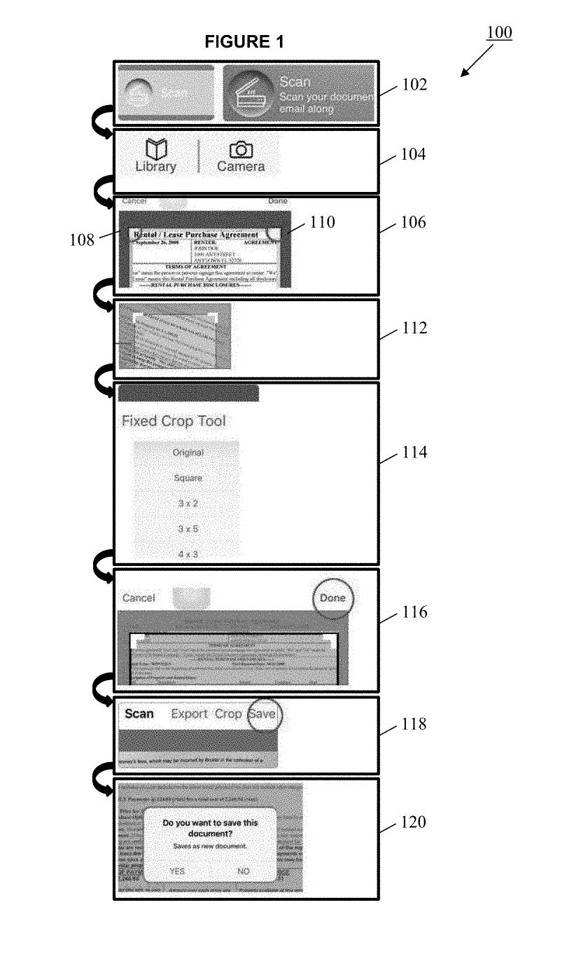

Turning now to FIG. 1, a procedure designated in general by element number 100 is shown in which a mobile device user easily may scan and/or resize documents using any mobile device such as a Smart Phone or portable tablet. According to this aspect of the disclosure, a user can scan or import an inert or inactive document in order to transform the document into a transformed or activated document that can be marked using the Mobimark™ marking system and/or signed, initialed, edited and/or merged with other activated documents, details of which are discussed below. The MobiDocx™ applications according to the present disclosure support, but are not limited to, inert or inactivated documents such as PDF, MS-Office™ (DOC, DOCX, XLS, XLSX, PPT), Open-Office, Text, HTML, RTF, CSV, images (JPG, BMP, PNG, TIFF) and Apple® Pages format.

FIG. 1 particularly shows at frame or step 102 a scan icon in a mobile device home page or sliding menu. The user will press, swipe, touch, or tap that icon or on a related text description. The user is then taken to step 104, as indicated schematically by a bold curved arrow, where the user may choose either a camera or to select files from a photo library. (Bold, curved arrows to the left of frames are used generally to indicate transitions in the figures and are not further described.) After tapping the camera or library file icon at step 104, a document image or photo appears in a blank screen shown at frame 106. After tapping on one of the circles indicated at 108 or 110, options to crop and resize the document appear beginning at frame 112. The user can rotate the document at step 112, and step 114 shows options to crop and resize. Thus, the document frame can be constrained to crop only a certain section of the image necessary for editing and/or for signing, which is explained in detail below.

To complete the scanning and preparation process of FIG. 1, the user can click or tap “Done” as shown in frame 116 and “Save” at the top right of the screen in 118 to save the document into the “Document Storage” as indicated at frame 120. After saving the now activated document, the user can choose to further edit the document or export the document as described below.

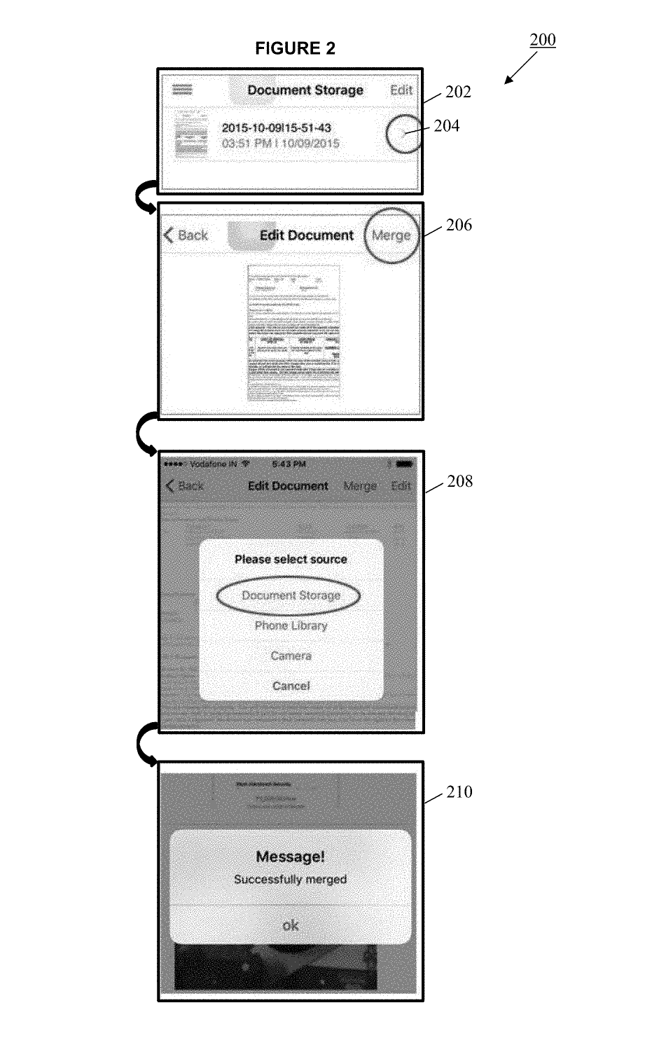

FIG. 2 shows a document merge process generally designated by element number 200. Here, an exemplary merge operation begins by clicking, touching, pressing or tapping on a “Document Storage” section shown at screenshot 202. In this example, a caret symbol (>) 204 located next to the desired document to be merged is tapped, which opens screen 206. Next, “Merge” in the upper right hand corner of the screen in frame 206 is tapped after which the user elects or chooses, as shown in frame 206, which file to merge with the previously selected document. As shown in frame 208, the user can merge documents from Document Storage, from the mobile device (e.g., cell phone) library or from the device camera. For instance, if the user chooses “Document Storage” in frame 208, software protocol will direct the user to Document Storage, and the user will choose which document to merge with the document shown in frame 206. The user will tap on the desired document, and the two documents will be activated and merged instantly and a successful merge message will be generated as shown in frame 210. The software protocol that enables the document merger 200 is shown in Table 1 below.

```
TABLE 1
- (void)openMergeOption:(id)sender {
  UIAlertView *addFileAlert = [[UIAlertView alloc]initWithTitle:@″Please select
source″ message:nil delegate:nil cancelButtonTitle:@″Cancel″
otherButtonTitles:@″Document Storage″,@″Phone Library″,@″Camera″,nil];
  addFileAlert.tag = 1000;
  addFileAlert.delegate = self;
  [addFileAlert show];
  addFileAlert = nil;
    }
-(void)alertView:(UIAlertView *)alertView
willDismissWithButtonIndex:(NSInteger)buttonIndex
{
  if(buttonIndex !=alertView.cancelButtonIndex)
  {
    if(alertView.tag == kRenameAlertTag){
      NSString *new_file_name = [alertView textFieldAtIndex:0].text;
      NSCharacterSet *whitespace = [NSCharacterSet
whitespaceAndNewlineCharacterSet];
      new_file_name =[new_file_name
stringByTrimmingCharactersInSet:whitespace];
      if([new_file_name isEqual:nil] || [new_file_name length]==0){
        [[MobiAlertViewManager sharedManager] showAlertWithTitle:@″Alert″
message:@″Please enter a filename.″];
      }else if([new_file_name length]<4 ){
        [[MobiAlertViewManager sharedManager] showAlertWithTitle:@″Alert″
message:@″File name must be minimum 4 character long.″];
      }else if([new_file_name length]>25){
        [[MobiAlertViewManager sharedManager] showAlertWithTitle:@″Alert″
message:@″File name must be less than 25 characters long.″];
      }else{
        [self.view endEditing:YES];
        [BOOL isChange = [[DatabaseManager
sharedManager]upateFilenameInDB:new_file_name document_id:self.document_id];
        if(isChange){
          self.fileName.text = new_file_name;
        }
      }
    }else{
      if(buttonIndex==1){
        if(self.total_doc_count>1){
          UIStoryboard*kamStoryboard = [UIStoryboard
storyboardWithName:@″Main″ bundle:nil];
          MergeDocListVC *mergeDocVC = [kamStoryboard
instantiateViewControllerWithIdentifier:@″MergeDocListVC″];
          mergeDocVC.doc_id = self.document_id;
          [self.navigationController pushViewController:mergeDocVC
animated:YES];
          mergeDocVC = nil;
        }else{
          UIAlertView *alert = [[UIAlertView alloc]initWithTitle:@″Message″
message:@″No document to merge with″ delegate:self cancelButtonTitle:@″Ok″
otherButtonTitles:nil, nil];
          [alert show];
        }
      }else if(buttonIndex==2){
        UIImagePickerController *picker = [[UIImagePickerController alloc] init];
        picker.delegate = self;
        picker.allowsEditing = NO;
        picker.sourceType = UIImagePickerControllerSourceTypePhotoLibrary;
        if(UI_USER_INTERFACE_IDIOM( ) == UIUserInterfaceIdiomPad)
          picker.modalPresentationStyle = UIModalPresentationFormSheet;
        [self presentViewController:picker animated:YES completion:NULL];
      }
      else
      {
        if(![UIImagePickerController
isSourceTypeAvailable:UIImagePickerControllerSourceTypeCamera])
        {
          [[MobiAlertViewManager sharedManager] showAlertWithTitle:@″Alert″
message:@″No Camera Detected!″];
        }else{
          UIImagePickerController *picker = [[UIImagePickerController alloc]
init];
          picker.delegate = self;
          picker.allowsEditing = NO;
          picker.sourceType = UIImagePickerControllerSourceTypeCamera;
          [self presentViewController:picker animated:YES completion:NULL];
        }
      }
    }
  }
}
-(void)tableView:(UITableView *)tableView
didSelectRowAtIndexPath:(NSIndexPath *)indexPath {
  ImageData *selected_data = [self.finalListArr objectAtIndex:indexPath.row];
  // MobiDocDetailVC *mobiDVC = [[MobiDocDetailVC alloc]init];
  //[mobiDVC MergeTwoDocuments:selected_data.slNo];
  [self mergeTwoDocuments:selected_data.slNo];
    }
-(void)mergeTwoDocuments:(int)selected_doc_id{
  NSMutableArray *merged_seq_holder = [[NSMutableArray alloc]init];
  NSArray *selec_doc_child_arr = [[NSMutableArray alloc]init];
  NSArray *current_doc_child_arr = [[NSMutableArray alloc]init];
  selec_doc_child_arr =[[DatabaseManager
sharedManager]getChildId_Array_OfDocument:selected_doc_id];
  if(selec_doc_child_arr.count>0){
    current_doc_child_arr =[[DatabaseManager
sharedManager]getChildId_Array_OfDocument:self.doc_id];
  }
  [merged_seq_holder addObjectsFromArray:selec_doc_child_arr];
  [merged_seq_holder addObjectsfromArray:current_doc_child_arr];
  NSLog@″selected_doc_id =%d″,selected_doc_id);
  NSLog@″Document ID =%d″,self.doc_id);
  NSMutableString *merged_seq_string = [[NSMutableString
alloc]initWithString:@″″];
  for(int i=0; i<merged_seq_holder.count; i++){
    [merged_seq_string appendString:merged_seq_holder[i]];
    if(i<(merged_seq_holder.count-1)){
      [merged_seq_string appendString:@″,″];
    }
  }
  BOOL isUpdate = [[DatabaseManager sharedManager]
updateChildInParentTable:selected_doc_id withChildSequence:merged_seq_string];
  if(isUpdate){
    BOOL isDell=[[DatabaseManager sharedManager] deleteDocument:self.doc_id];
    if(isDel){
      NSUserDefaults *userD = [NSUserDefaults standardUserDefaults];
      if(userD){
        [userD setInteger:selected_doc_id forKey:@″merged_document_id″];
        [userD setInteger:1 forKey:@″is_from_mergeView″];
      }
      [self goBack];
    }
  }
    }
-(BOOL)updateChildInParentTable:(int)parent_id
withChildSequence:(NSMutableString *)child_seq{
  BOOL isSaved = NO;
  const char *sqliteQuery = ″UPDATE IMAGE_TBL SET CHILDS =? WHERE
ID=?″;
  sqlite3_stmt* statement;
  if([self openDatabase]){
    if(sqlite3_prepare_v2(mobidocxDB, sqliteQuery, −1, &statement, NULL) ==
SQLITE_OK){
      sqlite3_bind_text(statement,1,[child_seq UTF8String],−
1,SQLITE_TRANSIENT);
      sqlite3_bind_int(statement,2,(int)parent_id);
      sqlite3_step(statement);
      isSaved = true;
    }else{
      NSLog@″Error while update statement. ′%s′″,sqlite3_errmsg(mobidocxDB));
    }
  }else{
    NSLog(@″SaveBody: Failed from sqlite3_prepare_v2. Error is: %s″,
sqlite3_errmsg(mobidocxDB));
  }
  // Close Database.
  sqlite3_finalize(statement);
  sqlite3_close(mobidocxDB3);
  return isSaved;
}
```

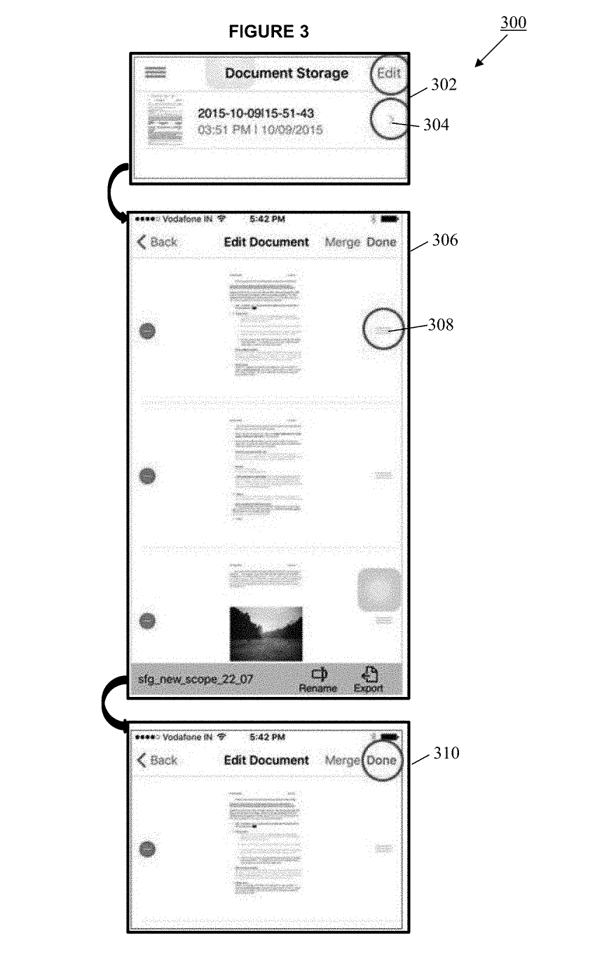

Turning to FIG. 3, an exemplary document rearrangement operation is indicated in general by element number 300. As shown in frame 302, after the user taps on a main document from “Document Storage,” the system will direct the user to a page showing all documents. In this example, the user taps a caret symbol (>) 304 located next to the document in which the user wishes to rearrange a page order. Here, the user taps “Edit” in the upper right hand corner of screen 302 to cause a transition to frame 306 where an exemplary three gray lines icon 308 will be shown to the right of each page of the document. The user will tap and hold onto the three lines 308 of a specific page that the user wishes to move. The user then slides or moves the page up or down to its desired position or placement within the document. When finished, the user taps “Done” as shown in frame 310, and the document will be saved with the user's new page order.

The software protocol that enables the document rearrangement 300 is shown in Table 2 below.

```
TABLE 2
-(BOOL)tableView:(UITableView *)tableView canMoveRowAtIndexPath.(NSIndexPath
*)indexPath
{
    return YES;
  }
- (void)tableView:(UITableView *)tableView moveRowAtIndexPath:(NSIndexPath
*)sourceIndexPath toIndexPath:(NSIndexPath *)destinationIndexPath {
    NSLog@″-----reorder images---------″);
    int source = (int)sourceIndexPath.row;
    int destinatioin = (int)destinationIndexPath.row;
    if(sourceIndexPath.row != destinationIndexPath.row){
      [self reArrangeInArrayFrom:source TO:destination];
    }
  }
-(void)reArrangeInArrayFrom:(int)from_pos TO:(int)to_pos{
    ChildImageData *tmp_data = [[ChildImageData alloc]init];
    tmp_data = self.imageListArr[from_pos];
    [self.imageListArr removeObjectAtIndex:from_pos];
    [self.imageListArr insertObject:tmp_data atIndex:to_pos];
    NSMutableString *seq_string = [[NSMutableString alloc]initWithString:@″″];
    ChildImageData *data = [[ChildImageData alloc]init];
    for(int i=0; i<self.imageListArr.count; i++){
      data = [self.imageListArr objectAtIndex:i];
      NSString *str_sl = [NSString stringWithFormat:@″%d″,data.slNo];
      [seq_string appendString:str_sl];
      if(i<(self.imageListArr.count-1)){
        [seq_string appendString:@″,″];
      }
    }
    // NSLog(@″%@″,seq_string);
    BOOL isUpdated = [[DatabaseManager
sharedManager]updateChildInParentTable:self.document_id withChildSequence:seq_string];
    if(isUpdated){
      [[NSNotificationCenter
defaultCenter]postNotificationName:MobiDetailsReloadNotification object:nil];
    }
}
```

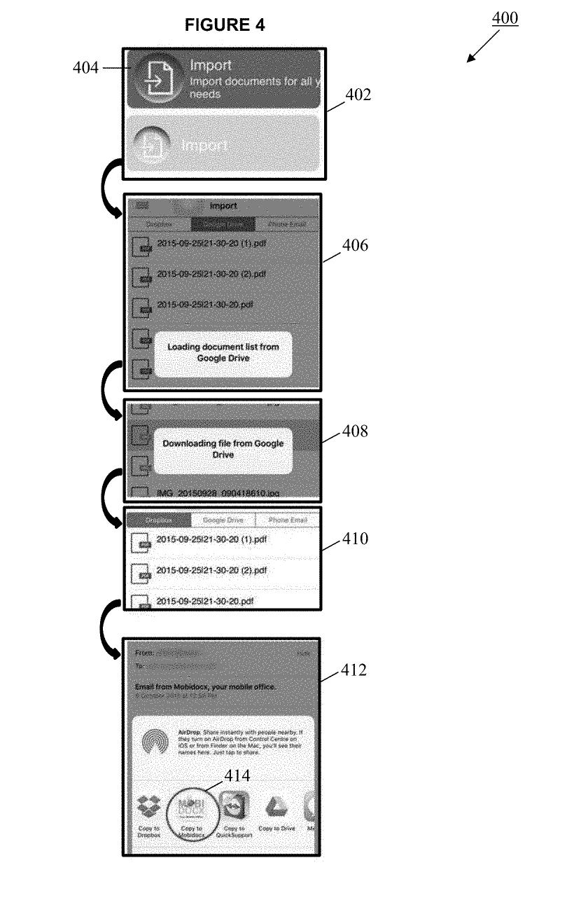

FIG. 4 shows a document import function generally indicated by element number 400 whereby users may import and export documents from email attachments, Dropbox™ and/or Google® Drive™ accounts and the like. By way of example, to import a document sent as an email attachment, the user first opens the email attachment within an email window of a mobile device. Next, frame 402 shows an action icon 404, which in this example may be a colored box with an arrow to draw the user's attention. If the user taps on icon 404, the system will then show, for instance, Dropbox™ and/or Google® Drive™ accounts. Here, in frames 406, 408, 410 and 412, after opening a document from a Google® Drive™ storage account and downloading the document, the user will decide on an option of “Send to” or “Export to” and then tap on the MobiDocx™ icon 414. Once imported successfully, the document will appear in the “Document Storage” section in MobiDocx™ app.

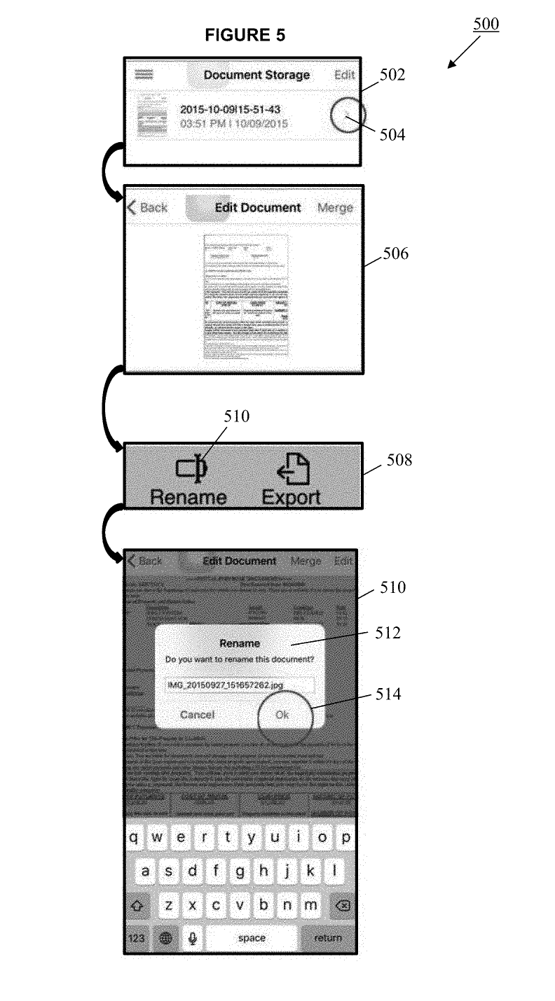

With respect to FIG. 5, a document renaming procedure is shown. The software process is designated broadly by the element number 500. Here, the user can begin renaming a document by tapping on the target document from within “Document Storage” as shown in frame 502. Specifically, the user taps a caret symbol (>) 504 located next to the desired document for editing. Frame 506 will appear showing the document to be renamed. At or near the bottom of the page as shown in frame 508, the user will click “Rename” 510. As shown in frame 510, a file rename screen or box 512 will appear, and the user may type a new name or title that the user wishes to rename the document. Once the new name is entered in the window, the user selects “OK” 514 and the system will save the renamed document into “Document Storage.”

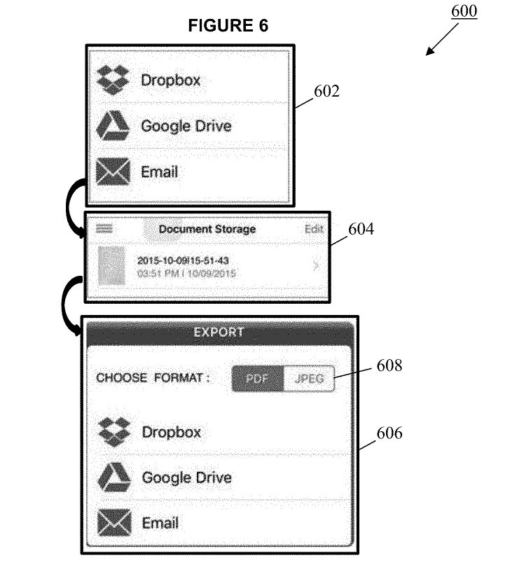

FIG. 6 shows a document-type conversion aspect of the disclosure generally designated by the element number 600, which enables the user to convert files into PDF or JPG formats in order to Mobimark™ mark, sign, initial, scan, merge, remove, resize and/or edit the document. Thereafter, the PDF or JPG document can be emailed or exported into Google® Drive™ or Dropbox™ accounts or the like.

More specifically, FIG. 6 shows in frame 602 that documents like PDF, docx, pptx, xlxs, etcetera can be downloaded from email or Google® Drive™ or Dropbox™ accounts. The documents will be saved automatically by the system into PDF form into document storage as shown in frame 604. For a single page document, the user may export files and choose pdf or jpg formats to export as indicated in frame 606 at selection point 608.

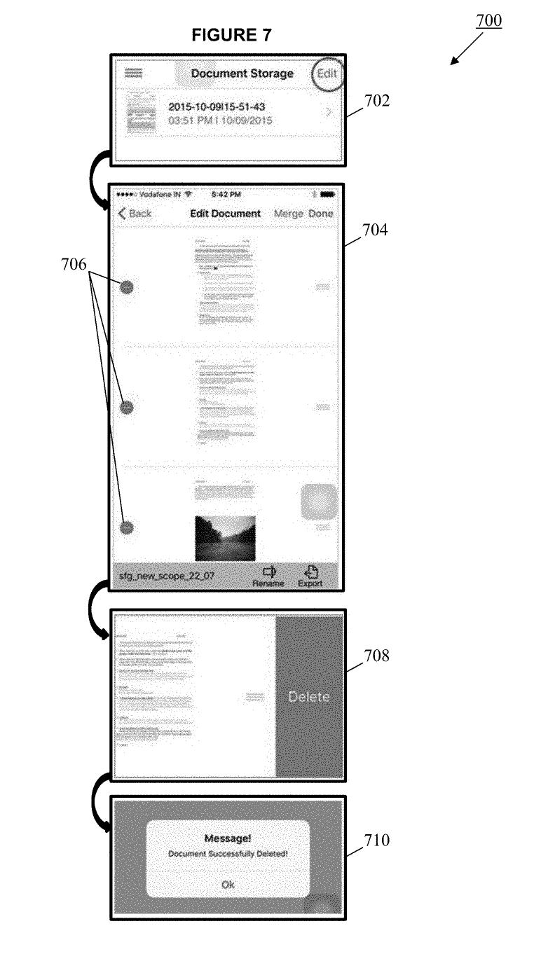

FIG. 7 shows a procedure broadly designated by element number 700 that enables a user to remove or delete a page from a document. According to this aspect of the disclosure, the user will go to the “Document Storage” screen shown in frame 702 where the user will choose the desired document for editing. At page 702, the user may select “Edit,” which will redirect the user to screen 704 showing exemplary red circles with white center lines 706 next to each document page. The user will choose which page to delete and tap on the appropriate deletion icon 706. A “Delete” warning or bar will appear as shown in frame 708. By selecting the “Delete” bar in frame 708, that page will be deleted from the overall document, which will generate an exemplary “Document Successfully Deleted!” message as shown by example in frame 710.

Related to the process in FIG. 7, to remove a document from document pages, after a user taps on a main document from the “Document Storage,” the user will be redirected to a page where all documents shown. The user will tap “Edit” in the right hand corner of the device screen, and an exemplary red circle with a white line will appear. The user will tap or swipe the circle/line and “Delete” will appear. If the user taps “Delete,” that page will be deleted from the document.

The software protocol that enables the document deletion procedure 700 is shown in Table 3 below.

```
TABLE 3
-(void)tableView:(UITableView *)tableView
commitEditingStyle:(UITableViewCellEditingStyle)editingStyle
forRowAtIndexPath:(NSIndexPath *)indexPath {
  ChildImageData *docInfo = self.imageListArr[indexPath.row];
  DatabaseManager *dbObj = [DatabaseManager sharedManager];
  BOOL isDel = [dbObj deleteImageFromChildTable:docInfo.slNo];
  if(isDel){
      [self deleteDocIDSfromMaster:docInfo.slNo];
      [self removeDocumentFromDirectory:docInfo.filePath];
  }
    }
#pragma mark - delete documents from Folder.
-(void)removeDocumentFromDirectory:(NSString *)filePath {
  NSFileManager *fileManager = [NSFileManager defaultManager];
  NSError *error;
  BOOL fileExists = [[NSFileManager defaultManager]fileExistsAtPath:filePath];
  if(fileExists){
      BOOL success = [fileManager removeItemAtPath:filePath error:&error];
      if(success){
        // [[MobiAlertViewManager sharedManager] showAlertWithTitle:@″Success!″
message:@″Successfully Deleted″];
      }else{
        //NSLog@″Could not delete file -:%@ ″,[error localizedDescription]);
        [[MobiAlertViewManager sharedManager] showAlertWithTitle:@″Error! ″
message:[error localizedDesciiption]];
      }
  }
    }
```

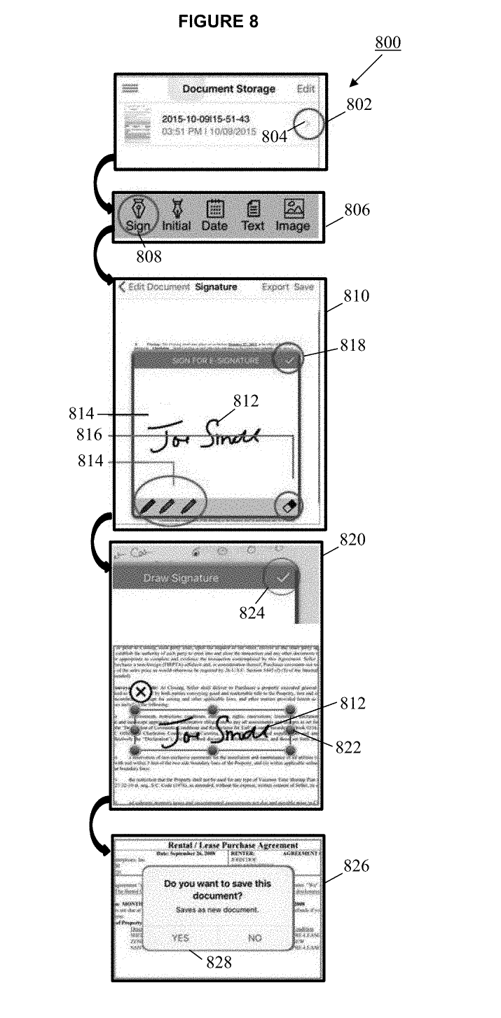

With reference now to FIG. 8, after a user has imported an inert document or documents into “Document Storage,” the user may edit or add signatures, initials, text, or images to any transformed or activated document. This exemplary procedure is broadly designated by element number 800 in FIG. 8. In this example, the user goes to “Document Storage” as shown in frame 802 and chooses which document to edit. The user taps a caret symbol (>) 804 located next to the desired document for editing, which will redirect the user to a single page document or to all pages of a multiple-page document. The user will tap the caret 804 again, which will transition to frame 806 showing features indicated by exemplary icons to add a signature, initials, a date, text, or images. For instance, to add signatures, the user can click on the “signature” icon 808. Tapping icon 808 will transition to screen 810 where the user can “free hand” a natural or personal signature 812 using a fingertip or stylus (not shown) in a white or blank box area 814, or change colors of the signature if desired as indicated by color icons 814, or erase or clear the signature 812 using an exemplary eraser icon 816. Once the user is satisfied with the signature 812, the user may tap a check mark 818 in frame 810, and the system will transition to document page 820. Here, the user may now adjust signature placement and edit a size of the signature 812 to fit on the document. The user need only drag the signature 812 by pulling on any node 822. Once the placement is optimal or as desired, the user may tap on the check mark 824 to save the signed document. This action will transition to frame 826 and open a “document save prompt” window 828. If the user selects “yes” in window 828, the signed document will be saved into Document Storage. The same protocol or steps described above can be followed to add initials, date, text and/or images.

The software protocol that creates and enables the free hand or natural signature process 800 on mobile devices is shown in Table 4 below.

```
TABLE 4
-(NSInteger)numberOfSectionsInTableView:(UITableView *)tableView {
  return 1;
}
-(CGFloat)tableView:(UITableView *)tableView heightForRowAtIndexPath:(NSIndexPath
*)indexPath
{
  return 65;
}
-(NSInteger)tableView:(UITableView *)tableView numberOfRowsInSection:(NSInteger)section
{
  NSLog@″count = %lu″,(unsigned long)self.tapOptionArr.count);
  return self.tapOptionArr.count;
}
-(UITableViewCell *)tableView:(UITableView *)tableView
cellForRowAtIndexPath:(NSIndexPath *)indexPath {
  static NSString *simpleTableIdentifier = @″TagOptionCell″;
  UITableViewCell *cell = [tableView
dequeueReusableCellWithIdentifter:simpleTableIdentifier];
  if(cell== nil) {
    cell=[UITableViewCell alloc]initWithStyle:UITableViewCellStyleDefault
reuseIdentifier:simpleTableIdentifier];
  }
  UIImageView *infoImageView = (UIImageView*) [cell.contentView viewWithTag:1000];
  infoImageView.image = [UIImage imageNamed:self.tapOptionImgArr[indexPath.row]];
  UILabel *infoTitle = (UILabel*) [cell.contentView viewWithTag:1001];
  infoTitle.text = sell.tapOptionArr[indexPath.row];
  return cell;
}
-(void)tableView:(UITableView *)tableView didSelectRowAtIndexPath:(NSIndexPath
*)indexPath
{
  NSString *valS = self.tapOptionArr[indexPath.row];
  [[NSUserDefaults standardUserDefaults]setValue:valS forKey:@″tag_mode″];
  CGRect signaturSize = CGRectMake(0,0,5,5);
  MobiResizableView *resizeableView = [[MobiResizableView
alloc]initWithFrame:signaturSize];
  resizeableView.signatureType = DateSignatire;
  self.doneHandler(resizeableView);
}
- (IBAction)onDoneClicked:(id)sender {
  self.doneHandler( );
}
```

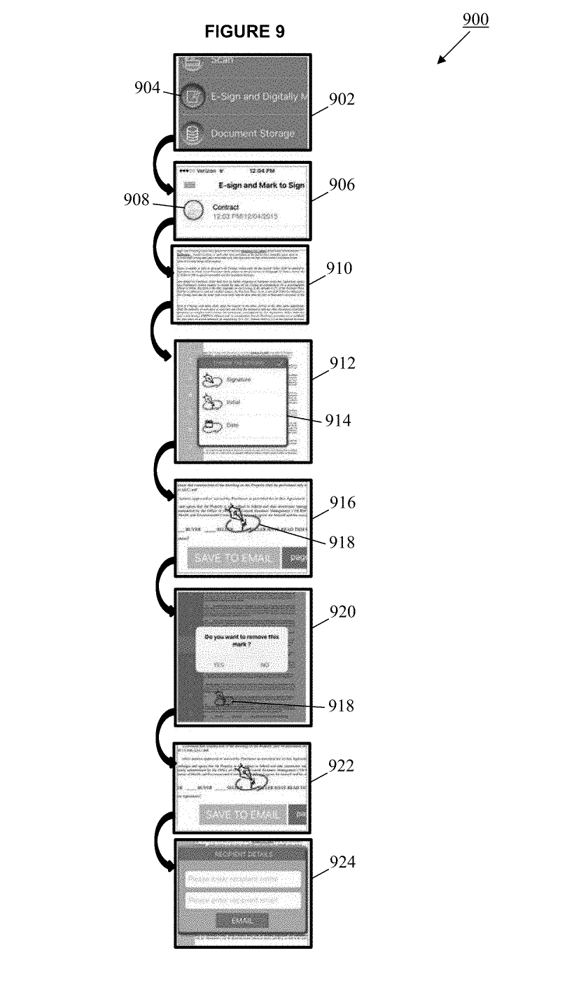

Turning now to FIG. 9, a document marking system generally designated 900 is provided according to another aspect of the disclosure. An exemplary system 900 available as a Mobidocx™ Application allows the user to digitally Mobimark™ a document to email to someone to esign, initial or date. More specifically, as frame 902 of FIG. 9 shows, the user begins by tapping an “E-Sign and Mobimark™” section 904. As shown in frame 906 the user may then select a document 908 to digitally mark it.

The software protocol that enables the marking process 900 on documents on mobile devices is shown in Table 5 below.

```
TABLE 5
_multiTabGesture = [[UITapGestureRecognizer alloc] initWithTarget:self
action:@selector(handleMultiTapGesture:)];
  _multiTabGesture.delegate = self;
  _multiTabGesture.numberOfTapsRequired = 2;
-(void)handleMultiTapGesture:(UITapGestureRecognizer *)tapRecognizer{
  if(_file_mode==SIGNONLY && _file_is_open==FILE_CLOSED)return;
  if(self.doc_Holder.frame.size.width!=self.orgCWidth){
    [[MobiAlertViewManager sharedManager]showAlertWithTitle:@″Message!″
message:@″Please tap on the Reset button to put MobiMarks.″];
    return;
  }
  if(!self.digital_mark_container_arr)self.digital_mark_container_arr = [[NSMutableArray
alloc]init];
  CGPoint point = [tapRecognizer locationInView:tapRecognizer.view];
  UIEvent *EV =[[UIEvent alloc]init];
  if(tapRecognizer.state==UIGestureRecognizerStateRecognized){
    if(!self.popoverManager)self.popoverManager = [[MobiPopoverManager alloc] init];
    [self.popoverManager show:TagOptionPopup from:EV onSelection:\hat{ }(id selectedIndex){
      // NSLog(@″Got IT″);
      self.popoverManager = nil;
      NSString *tag_mode = [[NSUserDefaults standardUserDefaults]
valueForKey:@″tag_mode″];
      NSString *icon_name = [self getIconName:tag_model;
      UIImageView *markView = [[UIImageView alloc]init];
      markView.frame = CGRectMake(point.x-30,point.y-30,60,60);
      markView.tag = self.current_page_no;
      markView.image = [UIImage imageNamed:icon_name];
      [self.doc_Holder addSubview:markView];
      [self.digital_mark_container_arr addObject:markView];
      //Collecting for Json Starts.
      NSMutableDictionary *josnInfo = [[NSMutableDictionary alloc]init];
      [josnInfo setValue:[NSNumber numberWithInteger:self.current_page_no]
forKey:@″page_no″];
      [jostInfo setValue:tag_mode forKey:@″type″];
      [josnInfo setValue:[NSNumber numberWithInteger:point.x] forKey:@″xpos″];
      [josnInfo setValue:[NSNumber numberWithInteger:point.y] forKey:@″ypos″];
      [_digital_mark_json_arr addObject:josnInfo];
      //Collecting for Json Ends.
      [self collectPagewiseElements:nil initial:nil date:nil mark:markView];
    }];
  }
}
```

With continued reference to FIG. 9, the user taps once on the document to open it as shown in frame 910, and taps twice on a target area within the document where the user wishes the Mobimark™ mark to appear. The system recognizes a “double tap” on a screen of a mobile device according to the following code in Table 6:

```
TABLE 6
_multiTabGesture = [[UITapGestureRecognizeralloc]
initWithTarget:setfaction:@selector(handleMultiTapGesture:)];
_multiTabGesture.delegate = self;
_multiTabGesture.numberOfTapsRequired = 2;
-(void)handleMultiTapGesture:(UITapGestureRecognizer * )tapRecognizer{
if(_file_mode==SIGNONLY&&_file_is_open==FILE_CLOSED)return;
if(self.doc_Holder.frame.size.width!=self.orgCWidth){
[[MobiAlertViewManagersharedManager]showAlertWithTitle:@″Message!″message:@″Please
tap on the Reset button to put MobiMarks.″];
return;
  }
if(!self.digital_mark_container_arr)self.digital_mark_container_arr =
[[NSMutableArrayalloc]init];
CGPoint point = [tapRecognizerlocationInView:tapRecognizer.view];
UIEvent *EV =[[UIEventalloc]init];
if(tapRecognizer.state==UIGestureRecognizerStateRecognized){
if(!self.popoverManager)self.popoverManager = [[MobiPopoverManageralloc] init];
    [self.popoverManagershow:TagOptionPopupfrom:EVonSelection:\hat{ }(idselectedIndex){
// NSLog(@″Got IT″);
self.popoverManager = nil;
NSString *tag_mode = [[NSUserDefaultsstandardUserDefaults] valueForKey:@″tag_mode″];
NSString *icon_name = [selfgetIconName:tag_mode];
UIImageView *markView = [[UIImageViewalloc]init];
markView.frame = CGRectMake(point.x-30,point.y-30,60,60);
markView.tag = self.current_page_no;
markView.image = [UIImageimageNamed:icon_name];
      [self.doc_HolderaddSubview:markView];
      [self.digital_mark_container_arraddObject:markView];
//Collecting for Json Starts.
NSMutableDictionary *josnInfo = [[NSMutableDictionaryalloc]init];
      [josnInfosetValue:[NSNumbernumberWithInteger:sell.current_page_no]
forKey:@″page_no″];
      [josnInfosetValue:tag_modeforKey:@)″type″];
      [josnInfosetValue:[NSNumbernumberWithInteger:point.x] forKey:@″xpos″];
      [josnInfosetValue:[NSNumbernumberWithInteger:point.y] forKey:@″ypos″];
      [_digital_mark_json_arraddObject:josnInfo];
//Collecting for Json Ends.
      [selfcollectPagewiseElements:nilinitial:nildate:nilmark:markView];
    }];
  }
}
```

More specifically, according to a feature of the disclosure as in FIG. 9, tapping twice causes frame 912 to open with a menu 914 having exemplary markers. In this example, the user may select from three types of Mobimark™ marks shown in the menu 914: a free hand signature, an initial, and a date. The user will tap the desired Mobimark™ mark from the menu 914, and, as shown in frame 916 a mark 918 will appear in the document at the point where the user initially tapped the document. Frame 920 queries the user as to whether the user is satisfied with mark location shown in frame 916, which is where the mark 918 will appear if “Yes” is selected in frame 920. On the other hand, the user can delete the mark 918 by selecting “No” and can restart process 900. Once the user is finished adding desired Mobimark™ mark, such as mark 918, in the document pages, the user can select the “Save to Email” box shown in frame 922. The system will redirect the user to frame 924 where the user can fill in a recipient's name and email address. The user can tap “email” shown at the bottom of frame 924, which will send the marked document to the named recipient for e-signature and/or initials at the designated Mobimark™ marks described above.

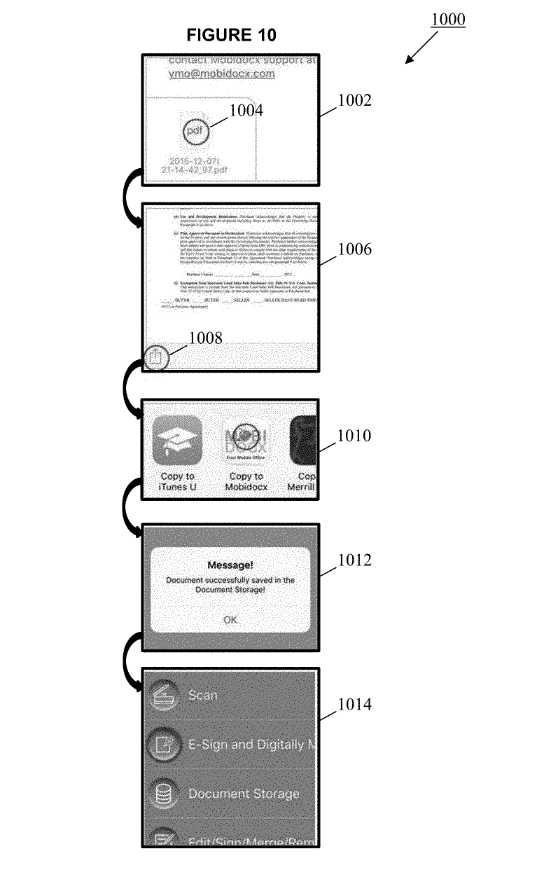

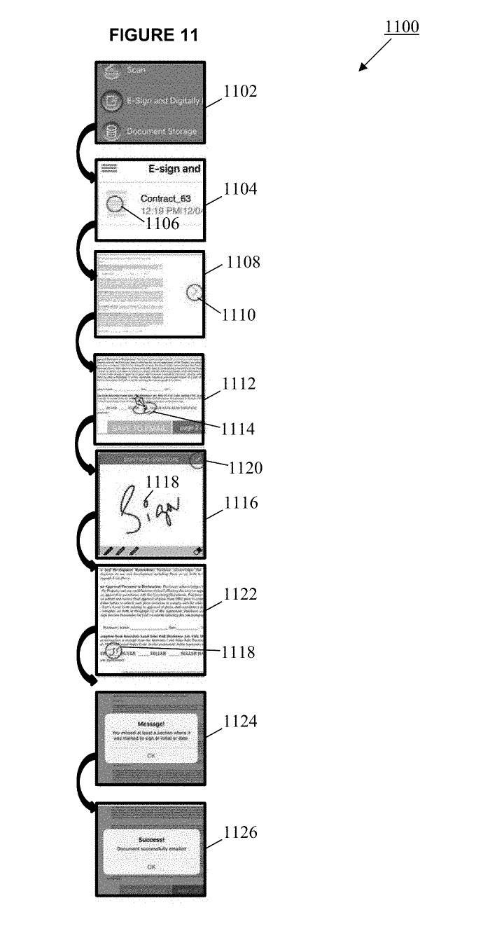

FIG. 10 is similar to FIG. 9, but in this case the recipient has received the user's email containing the marked document as described in FIG. 9. Thus, FIG. 10 shows a procedure 1000 for opening a document that is to be digitally e-signed or initialed. Presumably, the recipient has downloaded the Mobidocx™ Application, which must be available on the recipient's mobile device in order to review and e-sign the marked document contained in the user's email. As frame 1002 shows in FIG. 10, the recipient will open the email from the user. The recipient will scroll to the bottom of the email to find the attached document 1004, which the recipient will tap to open. When the document opens as shown in frame 1006, the recipient will tap again on the document and, in this example, at the bottom left side of the page a box and arrow icon 1008 will appear. The recipient will tap on icon 1008 and frame 1010 will open. The recipient will scroll over and tap the icon labeled “Copy to Mobidocx” in frame 1010. A message will appear in frame 1012 notifying the recipient that the document has been saved into Mobidocx's “Document Storage.” The recipient will click “OK” in frame 1012 to continue with a signing process shown in frame 1014 and described in greater detail with respect to FIG. 11.

As introduced in FIG. 10, a process 1100 to digitally e-sign or initial a document received by email on a mobile device is shown in FIG. 11. More specifically, after the recipient has imported the marked document within the Mobidocx™ Application as described, for example, in FIGS. 4 and 10 above, the recipient opens the Mobidocx™ Application by tapping on the “E-Sign and Mobimark™” section 1102. As shown in frame 1104, the recipient taps on the target document 1106, which will redirect the recipient to detailed pages of the document in frame 1108. Beginning with the first page in frame 1108, the recipient will tap on an arrow 1110 to enhance or enlarge the page. In enhanced frame 1112, the recipient will see a mark or marks 1114 indicating where the recipient is to e-sign and/or initial. The recipient will tap on each mark 1114, which will cause respective signature boxes or windows to open as shown in frame 1116. The recipient may sign in the signature box providing a free hand signature 1118 using a fingertip or stylus (not shown). After the signer has e-signed or initialed, the signer may click a checkmark 1120 to save the signature or initial 1118.

In one aspect of the disclosure five (5) different signers can sign and initial any document. For a different document, another group of 5 signers can be accommodated. Dates, text, and images can also be added to any documents, and a signer can sign and initial as many times as needed on any document.

With reference now to FIG. 11, as shown in frame 1122 the recipient/signer may need to reduce a size of the signature/initial using compression toggles with fingertip action. Additionally, the system will send an alert message as shown in frame 1124 if the recipient overlooked a marked section for signature/initial. Once the recipient is finished reviewing each page and has signed/initialed where requested by the Mobimark™ marks 1114, the recipient will click on a box labeled “Save to Email,” which will return email the final signed document to the sender and also save a copy of the signed document to the recipient's storage as indicated in frame 1126.

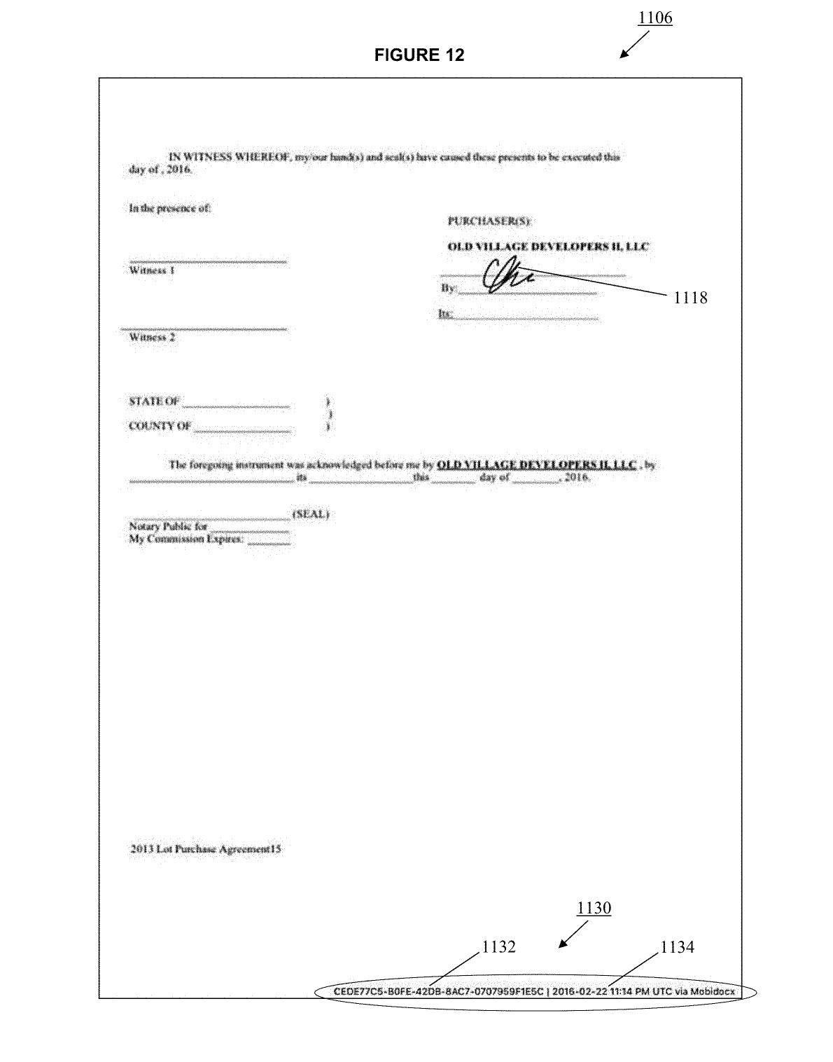

FIG. 12 most clearly shows the document 1106 from FIG. 11. In addition to the natural signature 1118, once the system has processed the document 1106, a Mobimark™ unique authenticating timestamp 1130 is imprinted on document 1106. In this example, the authentication stamp 1130 is located at or near a bottom portion of the document 1106, although the position may be adjusted as needed. As shown, a unique identification code 1132 and universal time code (UTC) 1134 are included in the stamp 1130. Here, the unique identification code 1132 is associated with the user's specific mobile device in a manner similar to a unique human fingerprint. The UTC 1134 portion of the stamp 1130 shows the exact time the document 1106 was processed and signed.

The software protocol that saves and imparts the unique identification code 1132 on documents such as document 1106 in FIG. 12 is shown in Table 7 below.

```
TABLE 7
- (void)saveScannedImage
{
  if(self.imageViewHolder.image==nil){
    [[MobiAlertViewManager sharedManager] showAlertWithTitle:@″Alert″
message:@″Please scan a document″];
    return;
  }
  if(self.isCurrentImageSaved){
    [[MobiAlertViewManager sharedManager] showAlertWithTitle:@″Alert″
message:@″Document already saved″];
    return;
  }
  MobiAlertViewManager *avm = [MobiAlertViewManager sharedManager];
  [avm showAlertWithTitle:@″Do you want to save this document?″ message@″″
titleArray:@[@″YES″,@″NO″] success:\hat{ }(NSUInteger selectedIndex) {
    if (selectedIndex==YES_BUTTON_INDEX) {
      if (sell.imageViewHolder!=nil){
        [self saveImageToDatabase];
      }
    }
  }];
}
*** Save Image To Database
===========================
-(void)saveImageToDatabase {
  NSDate *now = [NSDate date];
  NSDateFormatter *dateFormatter = [[NSDateFormatter alloc] init];
  [dateFormatter setDateFormat:@″yyyy-MM-dd|HH-mm-ss″];
  NSString *fileName = [dateFormatter stringFromDate:[NSDate date]];
  NSString *file_time = @″″;
  [dateFormatter setDateFormat:@″hh:mm a | MM/dd/yyyy″];
  file_time = [dateFormatter stringFromDate:now];
  UIImage *cropped_image = self.imageViewHolder.image;
  NSData *imageData = UIImageJEGRepresentation(cropped_image,0.6);
  self.full_Path=@″″;
  NSFileManager *fileManager = [NSFileManager defaultManager];
  NSArray *paths = NSSearchPathForDirectoriesInDomains(NSDocumentDirectory,
NSUserDomainMask, YES);
  NSString *documentsDirectory = [paths objectAtIndex:0];
  self.full_Path = [documentsDirectory stringByAppendingPathComponent:[NSString
stringWithFornat:@″%@.jpg″, fileName]];
  // Saves the file in the document folder.
    self.isSavedInDocs = [fileManager createFileAtPath:self.full_Path contents:imageData
attributes:nil];
  int last_parent_id = 0;
  int last_child_id = 0;
  NSMutableString *child_seq_string = [[NSMutableString alloc]initWith String:@″″];
  if(self.isSavedInDocs){
    self.save_file_name = [[NSMutableString alloc]initWithString:fileName];
    last_parent_id = [[DatabaseManager sharedManager] saveImagesToBD:fileName
file_time:file_time];
    if( last_parent_id!=0 ) {
      last_child_id = [[DatabaseManager sharedManager]
saveImagePathToChildDB:self.full_Path];
      [child_seq_string appendString:[NSString stringWithFormat:@″%d″,last_child_id]];
    }
    if([child_seq_string isEqual:nil]){
      child_seq_string = [[NSMutableString alloc]initWithString:@″″];
    }
    self.isCurrentImageSaved = [[DatabaseManager sharedManager]
updateChildInParentTable:last_parent_id withChildSequence:child_seq_string];
    if (self.isCurrentImageSaved) {
      [self enableOrDisableBarButtons:NO];
      [[MobiAlertViewManager sharedManager]showAlertWithTitle:@)″Success!″
message:@″Image successfully saved in the Document Storage!″];
      [[NSNotificationCenter defaultCenter]
postNotificationName:MobiListReloadNotification object:nil];
    }
  }
}
**** Update ChildIn Parent Table
===========================
-(BOOL)updateChildInParentTable:(int)parent_id withChildSequence:(NSMutableString
*)child_seq{
  BOOL isSaved = NO;
  const char *sqliteQuery = ″UPDATE IMAGE_TBL SET CHILDS =? WHERE ID=?″;
  sqlite3_stmt* statement;
  if([self openDatabase]){
    if(sqlite3_prepare_v2(mobidocxDB, sqliteQuery, −1, &statement, NULL) ==
SQLITE_OK){
      sqlite3_bind_text(statement,1,[child_seq UTF8String],−1,SQLITE_TRANSIENT);
      sqlite3_bind_int(statement,2,(int)parent_id);
      sqlite3_step(statement);
      isSaved = true;
    }else{
      NSLog@″Error while update statement. ′%s′″,sqlite3_errmsg(mobidoexDB));
    }
  }else{
    NSLog(@″SaveBody: Failed from sqlite3_prepare_v2. Error is: %s″,
sqlite3_errmsg(mobidocxDB));
  }
  // Close Database.
  sqlite3_finalize(statement);
  sqlite3_close(mobidocxDB);
  return isSaved;
}
```

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

That which is claimed is:

1. A system for digitally marking a document on a mobile device, the system comprising:
a first mobile platform embedded with a first application configured for transforming an inert document into an operational document on the first mobile platform; wherein a target area is marked within the operational document on the first mobile platform; and
a second mobile platform embedded with a second application compatible with the first application; wherein, upon receipt of the operational document, the second mobile platform enables a natural signature in the target area.

2. The system as in claim 1, wherein the first mobile platform is one of a smart telephone, a portable pad and a portable laptop computer.

3. The system as in claim 1, wherein the inert document is selected from the group consisting of a PDF document, a DOC, DOCX, XLS, XLSX, or PPT extension document, a text, an HTML document, an RTF document, a CSV document, a JPG, BMP, PNG, or TIFF image, and combinations thereof.

4. The system as in claim 1, wherein the second mobile platform is one of a smart telephone, a portable pad and a portable laptop computer.

5. The system as in claim 1, wherein the natural signature is applied by one of a fingertip and a stylus.

6. A method for digitally marking a document on a mobile device, the method comprising:
loading an application on an initiating mobile platform, the application being configured to manipulate a digital document by:
transforming the digital document using a manipulation protocol, the protocol enabling addition of document markers selected from the group consisting of a natural signature, natural initials, a date, text, images and combinations thereof;
generating the document markers in the transformed digital document;
sending the transformed digital document to a recipient mobile platform;
creating a tertiary digital document from the transformed digital document by addition on the recipient mobile platform of at least one of the natural signature, the natural initials, the date, the text, the images or a discrete recipient mobile platform identifier; and
returning the tertiary digital document to the initiating mobile platform.

7. A platform for merging documents on a mobile device, the platform comprising:
a mobile platform embedded with an application configured for transforming a first inert document into a first operational document and for transforming a second inert document into a second operational document, wherein upon activation of the application, the mobile platform causes the first operational document and the second operational document to merge.

8. A system for applying natural signatures to a document on a mobile device, the system comprising:
importing a document into a first mobile platform;
transforming the document into an activated document on the first mobile platform, the activated document enabled to receive a natural signature, a natural initial set, a date, a text, an image, a discrete recipient mobile platform identifier and combinations thereof;
receiving the activated document on a second mobile platform; and
adding in the activated document on the second mobile platform at least one of the natural signature, the natural initial set, the date, the text, the image and the discrete recipient mobile platform identifier to form an authenticated document.

9. The system as in claim 8, wherein the first mobile platform is one of a smart telephone, a portable pad and a portable laptop computer.

10. The system as in claim 8, wherein the document is selected from the group consisting of a PDF document, a DOC, DOCX, XLS, XLSX, or PPT extension document, a text, an HTML document, an RTF document, a CSV document, a JPG, BMP, PNG, or TIFF image, and combinations thereof.

11. The system as in claim 8, wherein the natural signature or the natural initial set are applied using one of a fingertip and a stylus.

12. The system as in claim 8, further comprising returning the authenticated document to the first mobile platform.

13. A mobile system serving activated documents, the mobile system comprising:
(a) an interactive mobile application containing an inert document defining a plurality of visually perceptible elements, the interactive mobile application belonging to a first portable host, wherein the inert document is activated by the interactive mobile application to associate an interactive marker to transform the inert document into an activated document; and
(b) a second portable host in communication with the first portable host, the second portable host programmed to:
(i) receive from the first portable host the activated document and a prompt;
(ii) automatically identify the interactive marker among the plurality of visually perceptible elements corresponding to the prompt;
(iii) in response to identification of the interactive marker, automatically retrieve stored data to enable a response to the prompt; and
(iv) using the data retrieved, enable the response in the form of a natural signature or natural initials and to transmit to the first portable host a tertiary document that displays:
(A) unique identifying information associated with the second portable host; and
(B) the natural signature or the natural initials disposed at the interactive marker among the plurality of visually perceptible elements.

14. The mobile system as in claim 13, wherein the first portable host is one of a smart telephone, a portable pad and a portable laptop computer.

15. The mobile system as in claim 13, wherein the inert document is selected from the group consisting of a PDF document, a DOC, DOCX, XLS, XLSX, or PPT extension document, a text, an HTML document, an RTF document, a CSV document, a JPG, BMP, PNG, or TIFF image, and combinations thereof.

16. The mobile system as in claim 13, wherein the natural signature or the natural initials are applied using one of a fingertip and a stylus.
